(19) United States
(12) Patent Application Publication
(10) Pub. No.: US 2021/0128961 A1
(43) Pub. Date: May 6, 2021

(54) CONTROL DEVICE FOR OPERATING A FIRE EXTINGUISHER SYSTEM AND EXTINGUISHER NOZZLE

(71) Applicant: IDEX Europe GmbH, Erlangen (DE)

(72) Inventors: Carsten SAUERBIER, Lauf an der Pegnitz (DE); Uwe KIRCHNER, Marloffstein (DE)

(73) Assignee: IDEX Europe GmbH, Erlangen (DE)

(21) Appl. No.: 16/633,492

(22) PCT Filed: Jul. 28, 2017
(86) PCT No.: PCT/EP2017/069120

§ 371 Date: Jan. 23, 2020

(51) Int. Cl. A62C 37/50; A62C 31/00

(52) U.S. Cl. CPC A62C 37/50; A62C 27/00; A62C 31/005

(57) ABSTRACT

A control device operates a fire extinguisher system. The system includes a hose having an extinguisher nozzle arranged at the end of the hose for releasing pressurized extinguishing fluid. A conveying pump pressurized conveying of the extinguishing fluid towards the extinguisher nozzle. A first supply line connects the conveying pump to a tank of a fire extinguisher vehicle. A second supply line connects the conveying pump to stationary extinguishing fluid source. A controller is positioned at a distance from the extinguisher nozzle and functions as an operations center. A control line runs along the hose to the nozzle end of the hose. A radio device connected to the control line converts signals from the control line into radio signals and outputting the signals. An operator carried portable radio device receives radio signals output by the radio device. An operator carried display displays information based on the transmitted radio signals.

The present invention relates to a control device for operating a fire extinguisher system according to the preamble of claim 1. The present invention further relates to an extinguisher nozzle according to claim 17.

### TECHNOLOGICAL BACKGROUND

In the case of a firefighting mission, the fire extinguisher vehicle is first brought into position and the source of the fire is first fought with extinguishing fluid, which is located in a tank of the fire extinguisher vehicle. This allows for the firefighting mission to begin as quickly as possible. Since the tank only allows for a limited volume and thus only a limited time for extinguishing, a further source of extinguishing fluid is simultaneously sought. These are usually permanently installed hydrants, streams, or lakes. These offer an unlimited volume of extinguishing fluid. However, finding and connecting an appropriate source of extinguishing fluid to the fire extinguisher system of the fire extinguisher vehicle requires a certain amount of time.

With the fire extinguisher nozzle at the end of the water hose, the firefighter fights the source of the fire by spraying pressurized extinguishing fluid onto the source of the fire. If the firefighter intends to withdraw from the source of the fire, the fire extinguisher nozzle can be actuated such that the extinguishing fluid no longer leaves the fire extinguisher nozzle almost undeflected; instead, an extinguishing fluid wall is formed which protects the firefighter from being affected by flames and/or heat when said firefighter withdraws. If the firefighter is no longer able to form an extinguishing fluid wall due to an abrupt interruption of the extinguishing fluid supply, there is a considerable risk to life and limb of the firefighter. As a result, the firefighter must always know how much extinguishing fluid is still in the tank and whether a connection to another source of extinguishing fluid has already been established. This is the only way to ensure that the firefighter can withdraw from the source of the fire in time, if necessary.

During a mission, the risk can increase if one or even more extinguisher nozzles, all of which are supplied by a conveying pump from the extinguishing fluid tank, are put into operation. As a result, the discharge rate of the extinguishing fluid tank can increase sharply. In this respect, it can occur that the firefighter no longer has the necessary time to form the extinguishing fluid wall.

Extinguishing fluid refers to extinguishing water or a mixture of extinguishing water and an additive in the form of foam or the like.

### DOCUMENTED PRIOR ART

A control device for operating a fire extinguisher system according to the preamble of claim 1 is known, for example, from DE 689 02 671 T2. This known control device comprises a cable communication system with a transmission line positioned in the water hose for a communication link between a firefighter standing at the end of the leading side of the water hose and the operating personnel on the side of the fire engine. Particularly a voice connection is supposed to be made possible with the cable communication system. For this purpose, a receiver and a microphone are accommodated in the helmet of the firefighter. The firefighter is therefore solely dependent on the cable communication with the operating personnel on the side of the fire engine. This idea is thus supposed to improve the voice communication between firefighter and operating personnel. If said voice communication is not available for whatever reason, even for a short period, there is an increased risk for the firefighter at the source of the fire.

EP 990 453 A1 shows a fire extinguisher device with an extinguishing gun which is connected to a high-pressure device via a hose. The end of the hose opposite the extinguishing gun is connected to two chambers via a three-way valve, wherein one chamber contains foam-free extinguishing water and the other chamber accommodates a water/foam mixture. An actuating device is provided on the extinguishing gun, which is connected to a base by means of an electrical line integrated in the hose.

G 87 10 073.8 shows a foam proportioning device for firefighting with a foam agent tank, a water tank, and an inlet connection for a hydrant, lake, or river. A changeover valve with a pivotable butterfly valve is provided in the region of the inlet connection.

From U.S. Pat. No. 7,987,916 B2, a control device for a fire extinguisher device with a control panel mounted inside or on the outside of a fire engine is known. With the control panel, the firefighter can select different modes of operation of the fire extinguisher device. In addition, the control device comprises a device for determining the pressure of a conveying pump connected to the tank. If the tank is empty, a warning signal is issued to the operator on the control panel.

WO 95/07526 shows an electro-optical device for generating a real operational scenario during firefighting. The device includes a video camera that can be accommodated in the helmet of a firefighter. The recorded data are transmitted to a data center. There, the transmitted data are combined with stored data, e.g., exact position data, for supporting the firefighting mission.

DE 10 2008 004 785 A1 describes a portable system for the protection and orientation of firefighters in buildings. Among others, the system comprises an infrared camera for recording thermal image data and a display device. The display device can be accommodated as a head-up display in the helmet of the firefighter. The data is transmitted via radio directly from the thermal imaging camera to the head-up display.

DE 20 2015 002 738 U1 discloses a fire extinguisher with an extinguishing gun connected via an extinguishing agent hose, wherein a sensor in the form of a thermal imaging camera or another heat detection device is mounted on the extinguishing gun, and the optical axis of the sensor runs approximately parallel to the nozzle tube axis of the extinguishing agent gun. Via an antenna, the sensor can be connected to a receiving device via a radio link. The receiving device can either be a display arranged on the extinguishing gun or an image generation device worn by the firefighter on the helmet, to which the data are transmitted via radio link.

DE 35 17 284 C2 describes a device for dispensing an extinguishing agent mixed with an additive. The device comprises an extinguishing agent gun at the end of a hose line, on which a button is arranged, with which the firefighter operating the extinguishing gun can directly activate a premixer for adding additives to the extinguishing agent. The button is connected to a control device via lines positioned in the hose line.

In the control system for a firefighting mission described in U.S. Pat. No. 8,418,773 B2, the firefighter standing at the end of the hose line operates a display and control panel which is connected via radio to a base station located on the fire engine. The display and control panel enables the firefighter to control the supply of extinguishing agent alone, i.e., without the help of an additional person at the fire engine. However, the radio transmission is often subject to interferences that can put the firefighter at considerable risk, especially if, e.g., a fire is located inside a building and reinforced concrete floors impede a radio transmission. The firefighter has to disconnect the tank when the tank is empty.

U.S. Pat. No. 9,220,935 B2 further discloses a nozzle for a firefighting mission with a display provided directly on the nozzle for displaying various parameters. The display is able to communicate with remote components. The display displays the water volume located in the water tank and the water pressure in the supply line to the stationary water reservoir. Knowing the amount of water, the firefighter is forced to use such knowledge to calculate the time remaining until the tank is empty. In addition, the discharge rate of the tank can suddenly increase if an additional extinguishing hose is supplied with extinguishing fluid via the tank. The firefighter at the first extinguishing fluid hose also does not know how intensive the consumption of extinguishing fluid will be at the newly operated second extinguishing fluid hose.

### PROBLEM ADDRESSED BY THE PRESENT INVENTION

The present invention addresses the problem of providing a new control device of the type in question for operating a fire extinguisher system which, at a simple structural implementation, offers increased safety for the firefighter located at the fire extinguisher nozzle. The present invention further addresses the problem of proposing a fire extinguisher nozzle suitable thereto.

### SOLUTION OF THE PROBLEM

The above problem is solved by a control device according to claim 1 and an extinguisher nozzle according to claim 17. Expedient embodiments of the control device according to the invention are claimed in the dependent claims.

Due to the fact that the controller transmits the data via control line means to the region of the extinguisher nozzle, and that a radio transmission over a very short distance from a point in the region of the extinguisher nozzle to the helmet of the firefighter take places only in said region, interferences due to influences, such as reinforced concrete floors and/or walls or the like, can be avoided particularly effectively. At the same time, it is convenient because no cables or the like have to be used.

The fact that a head-up display is expediently provided as a display ensures a particularly good visibility of the information from the operations center for the firefighter in action, especially under often difficult visibility conditions, caused, e.g., by particularly poor lighting conditions, smoke, or soot.

If the information shown in the display on the basis of the radio signals can be displayed, preferably simultaneously, in a further display which is located in the region of the operations center, the firefighter serving in the operations center always has control over the information appearing on the display of the firefighter at the source of the fire.

According to one embodiment of the present invention, a data interface is additionally provided which allows for a parallel data transmission via a communication cable between the control line and the display. As a result, an emergency backup device is provided.

According to an expedient embodiment of the present invention, at least one of the following information provided by the operations center can be displayed in the display of the firefighter:
the current filling level of the tank with extinguishing fluid,
the time remaining for releasing extinguishing fluid from the tank,
a status indication with regard to the existence and/or non-existence of a conveying connection of extinguishing fluid from the stationary (unlimited) extinguishing fluid source to the fire extinguisher device,
a status indication with regard to the existence and/or non-existence of a radio link and/or
an alarm signal.

The radio link can alternatively also be designed bidirectionally, and so it is also possible to receive radio signals by means of the radio device connected to the control line in the end region of the extinguisher nozzle, which are output by the radio device carried by the firefighter. For example, this makes it possible to establish a voice communication connection and/or even a voice control device to the operations center.

In particular, audio and/or video communications can be transmitted in one or even both directions. Accordingly, the control device according to the invention can also be used to carry out a bidirectional voice communication.

The extinguisher nozzle is either an extinguisher nozzle that is portable by the firefighter and attached to the end of a flexible hose, or alternatively an extinguisher nozzle that is permanently mounted on a foundation (also called “monitor” in technical jargon).

Since the first supply line to the tank and the second supply line to the stationary extinguishing fluid source are connected to a pressure-controlled manifold valve provided upstream of the conveying pump, the switching of the extinguishing fluid flow from the tank to the stationary extinguishing fluid point can be automated. As a result, it is no longer necessary for the firefighter to monitor valves in the supply lines of the conveying pump and to switch off the respective inflows. The switching takes place automatically with the manifold valve, preferably in a pressure-controlled manner, without a person as an operator having to intervene in the process.

The manifold valve is expediently actuated via the pressure applied to the manifold valve in the second supply line. In the basic position of the manifold valve, the tank is first emptied during the operation of the fire extinguisher system and, when the specified pressure is applied to the manifold valve in the second supply line, the supply of extinguishing fluid from the tank is switched over to the stationary extinguishing fluid source.

Since the pressure applied in the second supply line to the manifold valve can be determined with a separate pump, the pressure control of the manifold valve can also be used when the extinguishing fluid from the stationary extinguishing fluid source is not pressurized (e.g., in case of a hydrant) but has to be suctioned.

The switching of the manifold valve expediently takes place at a pressure threshold value that is adjustable.

Expediently, the manifold valve is a manifold valve, the pressure-dependent switching point of which is determined by an elastic element, e.g., a spring, and/or by magnetic means.

Alternatively or in addition to the information that can be shown on the display, the switching position of the manifold valve can also be shown on the display if required.

Since a return line is provided from the conveying pump to the tank, it is possible during the procuring of extinguishing fluid from the stationary extinguishing fluid source that a specific percentage of the delivered quantity of extinguishing fluid can be fed back into the tank; as a result, said tank can be refilled during the extinguishing operation.

The present invention also relates to an (additionally independently claimed) extinguisher nozzle for use in a fire extinguisher system, preferably for use in a control system for operating a fire extinguisher system according to one of the claims 1 to 16. The extinguisher nozzle according to the invention is equipped with a radio device that can be connected to control line means running along the hose for extinguishing fluid for establishing a data communication connection, wherein the radio device is designed to output signals or data from the operations center via the control line means and/or to receive signals originating from a transmitter, e.g., a transmitter located in the region of the display.

An autarkic electric energy source, preferably a rechargeable battery, is provided on the extinguisher nozzle or at least in the region of the extinguisher nozzle for supplying energy to the radio device, or electrical energy for operating the radio device is made available via the control line means or via an additionally provided power supply line running parallel to the control line means. For this purpose, contact means can be provided in the region of the connection of the extinguisher nozzle to the hose end to ensure a signal connection and/or electrical connection for the energy supply.

### DESCRIPTION OF THE INVENTION USING EMBODIMENTS

In the following, expedient embodiments of the present invention are described in more detail using drawings. The drawings show in:

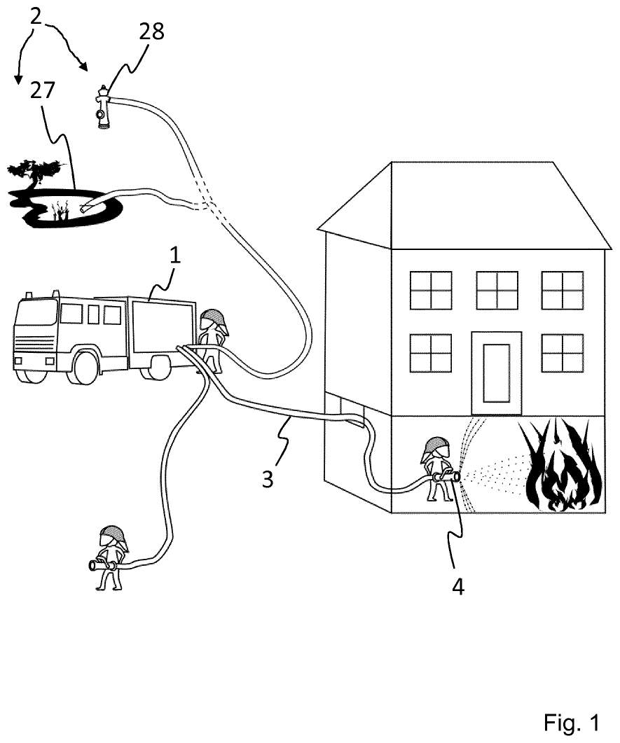

FIG. 1 a highly simplified depiction of a situation of a typical firefighting mission when fighting a fire source;

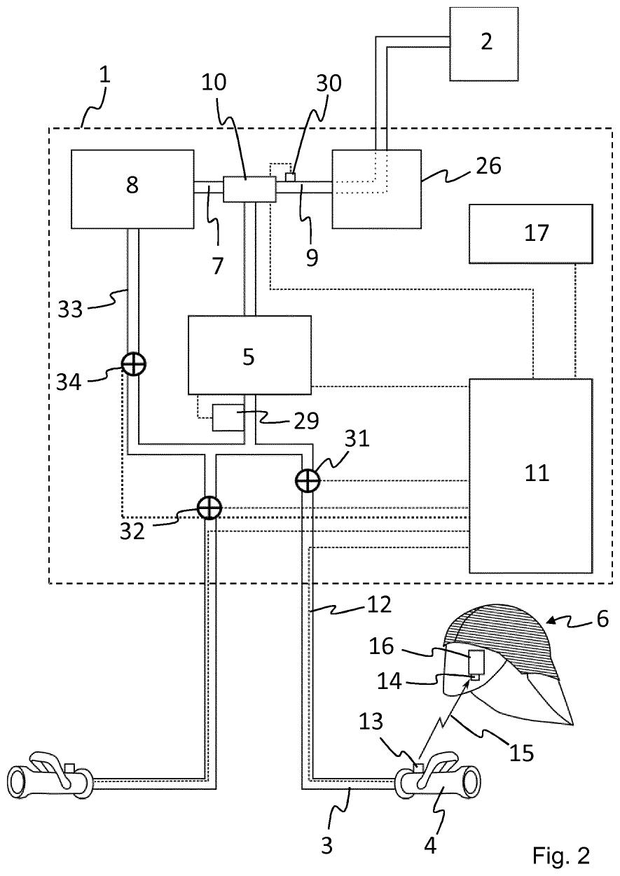

FIG. 2 a highly simplified schematic depiction of a control device according to the present invention;

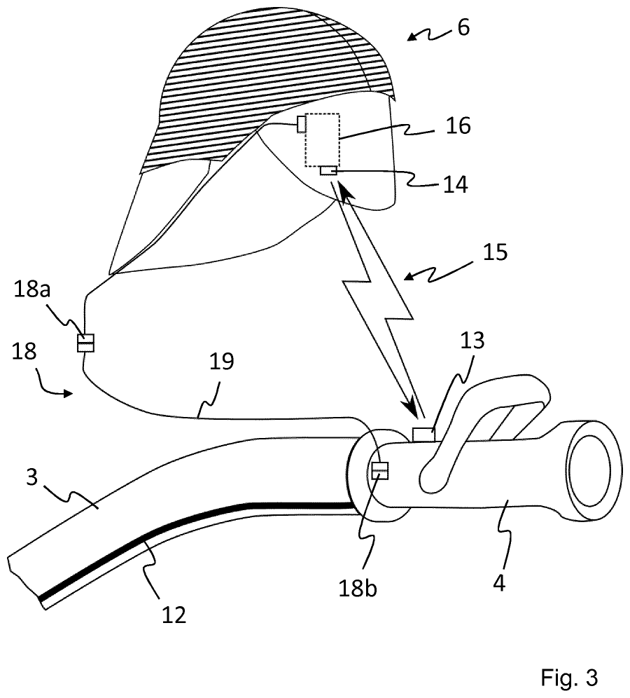

FIG. 3 a highly simplified schematic depiction of the region of the communication bridge between the extinguisher nozzle and the display provided in the helmet of the firefighter;

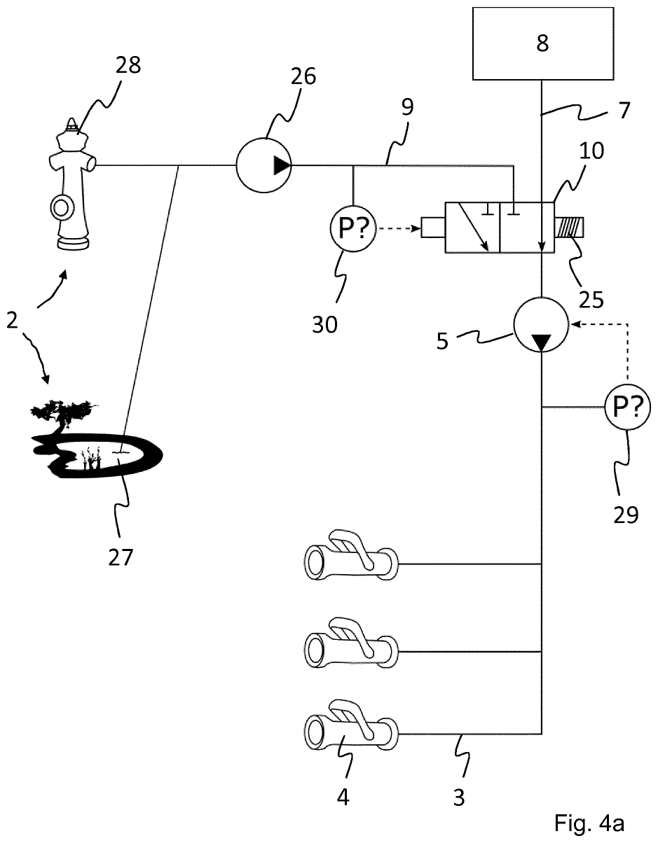

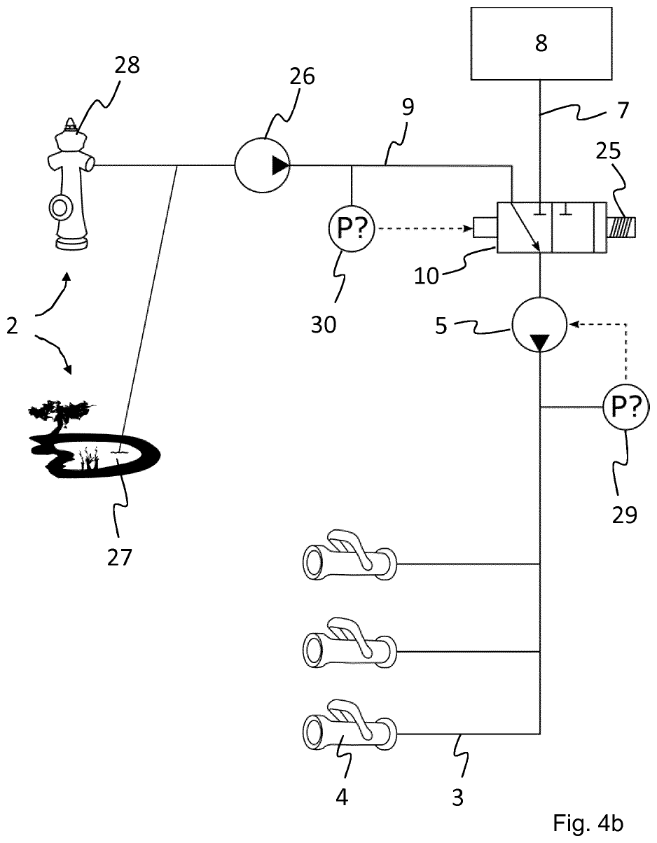

FIG. 4 a highly simplified schematic depiction of the use of a manifold butterfly valve, namely in the switching position of conveying extinguishing fluid from the tank (FIG. 4a), and in the switching position of conveying extinguishing fluid via the stationary extinguishing fluid source (FIG. 4b); and

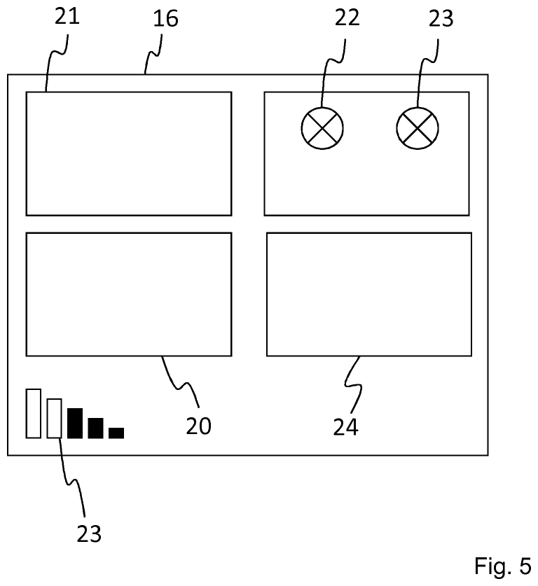

FIG. 5 a highly simplified schematic depiction of the display in the display carried by the firefighter.

FIG. 1 shows a situation of a typical firefighting mission when fighting a fire that has broken out in a basement room of a building. After the arrival of the fire engine 1, a firefighter goes into the basement of the building with the hose 3 and releases extinguishing fluid for immediate firefighting via the extinguisher nozzle 4. The extinguishing fluid is obtained from a tank in the fire engine 1. This makes it possible to start fighting the source of the fire as soon as the fire engine 1 arrives. At the same time, further firefighters search the area for an unlimited extinguishing fluid source 2, such as a hydrant, a lake 27, or a stream. This can take a considerable amount of time. As soon as an unlimited extinguishing fluid source has been found, it is connected to the fire engine 1 via a feed line. The hose 3 located at the source of the fire can then be supplied with extinguishing fluid from the unlimited extinguishing fluid source.

For firefighting, a plurality of hoses is usually provided in a fire engine 1, which can also be used simultaneously if required. For the sake of clarity, FIG. 1 only shows a second hose with an extinguisher nozzle arranged at its end. This extinguisher nozzle is operated by a further firefighter.

In order to fight the fire, the firefighter can manually adjust the extinguisher nozzle 4 such that the extinguishing fluid is released from the extinguisher nozzle 4 at a small opening angle. As a result, a maximum extinguishing effect on the source of the fire can be achieved. However, if the source of the fire spreads despite the firefighting efforts and threatens the firefighter, the firefighter can manually adjust the extinguisher nozzle 4 such that the extinguishing fluid is released by the extinguisher nozzle 4 at a very large opening angle. As a result, the firefighter is protected from fire and/or excessive heat and can leave the building safely. Both modes of operation of the extinguisher nozzle 4 are shown schematically in FIG. 1. If there is an unforeseen interruption in the supply of extinguishing fluid, the firefighter can suddenly find himself in a life-threatening situation because said firefighter can, for protection, no longer release extinguishing fluid at a very large opening angle.

FIG. 2 shows a simplified schematic diagram of the control device according to the invention. In this case, the components surrounded by the dashed line are preferably located in the region of the fire extinguisher device, i.e., in the region of the fire extinguisher vehicle 1. The components comprise a controller 11 with a multiplicity of control and/or signal lines (dotted lines), which are connected to different functional components of the overall system. In particular, the tank 8 for providing extinguishing fluid directly on the fire extinguisher vehicle 1 is shown. The tank 8 is connected via a first supply line 7 to the conveying pump 5, e.g., a centrifugal pump.

In addition, a second supply line 9 is provided which is connected to a feed line and supplies the conveying pump 5 with extinguishing fluid from the stationary extinguishing fluid source 2.

The first supply line 7 and the second supply line 9 open into a preferably pressure-controlled manifold valve 10 provided upstream of the conveying pump 5. The manifold valve 10 thus ensures that, depending on the pressure applied to the second supply line 9, the inflow to the conveying pump 5 is switched from the tank 8 to the stationary extinguishing fluid source 2. In FIG. 2, the pressure control 30 of the manifold valve 10 is only shown schematically.

The hose 3, at the end of which a portable extinguisher nozzle 4 is located, is supplied with extinguishing fluid via the conveying pump 5. For the sake of clarity, only a single additional hose with an extinguisher nozzle is shown in FIG. 2. However, if necessary, a multiplicity of extinguisher nozzles and associated hoses, which are supplied with extinguishing fluid via the conveying pump 5, can also be provided. In the region of each supply line to the extinguisher nozzle, a valve 31, 32 is located which is connected to the controller 11 via a control and/or signal line and can be actuated via the controller 11.

The output of the conveying pump 5 is also connected to a return line 33, via which, also controlled via a valve 34 connected to the controller 11, extinguishing fluid from the stationary extinguishing fluid source 2 can be returned to the tank 8 in order to refill it.

Reference sign 29 denotes a device, or a so-called “pressure governor,” for controlling the conveying pump. This device is capable of adapting the pump output to the required output rates of extinguishing fluid. If, for example, a pressure drop is effected by activating a further hose or a further extinguisher nozzle, the device 29 for controlling the conveying pump controls the pump output such that the latter is increased in order to adapt the conveying pressure of extinguishing fluid in the respective hose to the previous level.

Reference sign 26 in FIG. 2 denotes a further pump which is provided to determine the pressure conditions in the second supply line 9 from the stationary extinguishing fluid source 2 to the conveying pump 5, provided that an extinguishing fluid source 2 has been found that is not pressurized. The pump 26 is preferably a type of air pump or suction pump which is provided to influence the pressure conditions in the second supply line 9 such that extinguishing fluid, for example, from a lower-lying lake or stream, flows via the supply line 9 toward the manifold valve 10 (possibly also located at a higher level). The pressure conditions created by the pump 26 in the second supply line 9 at the entrance to the manifold valve 10 are used for triggering the switching process of the same. As a result, the control device can switch over automatically as soon as a local extinguishing fluid source 2 has been found and connected to the fire extinguisher device.

FIG. 2 further shows that the controller 11 is connected via control line means 12 to a radio device 13 connected to the control line 12 in the region of the extinguisher nozzle 4. The control line means 12 can either be attached to the hose 3 on its jacket or integrated into the hose wall. The control line means 12 is preferably an electric conductor for the transmission of electrical signals, data and/or for energy supply. The radio device is preferably a radio module for data transmission between transmitter and receiver over short distances, such as WPAN or WLAN. This type of radio transmission technology is preferably geared towards covering the work area around the radio device 13.

Furthermore, a radio device 14 to be carried by the firefighter operating the extinguisher nozzle 4 is provided, which is capable of receiving the radio signals 15 output by the radio device 13 and displaying them on a display 16, preferably in the form of a head-up display, to be carried by the firefighter operating the extinguisher nozzle 4. As a result, only a very short transmission path of the data is established by radio directly in the work area of the firefighter, which is therefore much less susceptible to interferences. In the embodiment of the present invention shown in FIG. 2, data is only transmitted in one direction, as is illustrated by the directional arrow of the radio signals 15 shown in FIG. 2.

If the display 16, as in FIG. 2, is configured as a head-up display in the helmet 6 of the firefighter, the firefighter, during a mission, is provided with particularly good visibility conditions with regard to information originating from the operations center, especially also often under poor visibility conditions caused, e.g., by poor lighting conditions, smoke, soot or the like.

A rechargeable battery (not depicted) can be provided on the extinguisher nozzle 4 or in the region thereof for supplying data to the radio device 13. Alternatively, the radio device 13 can also be supplied with electrical energy via the control means 12 or via additional electrical energy-carrying conducting means (also not depicted), which also run in or on the hose 3.

The information shown in the display 16 can preferably be displayed, preferably simultaneously, in a display 17 of the fire extinguisher device or the fire extinguisher vehicle 1, and so the operator at the fire engine simultaneously sees the data or information transmitted to the firefighter at the extinguisher nozzle 4.

FIG. 3 shows a further embodiment of the communication bridge between the extinguisher nozzle 4 and the display 16. In this case, a data interface 18 can additionally be provided, which also makes it possible to establish a cable connection from the control line 12 to the display 16. For this purpose, at least one, preferably two plug contact connections 18a, 18b can be provided as the data interface 18. The additional data interface 18 only serves as a backup position for emergencies.

The display 16 provided as a head-up display in the helmet 6 of the firefighter is connected via an energy source (not depicted in FIG. 3), e.g., a rechargeable battery. The short radio transmission bridge according to the invention in the region of the extinguisher nozzle 4 makes it possible in a simple manner to provide the additional data transmission via a communication cable 19 as a backup position.

In a further embodiment, the invention also makes it possible to establish a bidirectional data transmission between the first and the second radio device 13 and 14. In addition to transmitting data to be shown in the display 16, voice files can preferably also be transmitted from the firefighter operating the extinguisher nozzle 4 to the controller 11 and/or voice files can be transmitted from the firefighter at the controller 11 to the firefighter at the extinguisher nozzle 4.

The drawing according to FIG. 4a shows the switching position of the manifold valve 10 when the conveying pump 5 is supplied with extinguishing fluid from the tank 8. The supply of extinguishing fluid from the tank 8 must be maintained until the supply of the conveying pump 5 is established via a stationary extinguishing fluid source 2. For this purpose, either a permanently installed hydrant 28 or a lake 27 or a stream, river or the like are suitable.

If a hydrant 28 is present, the second inflow 9 of the conveying pump 5 is connected to the connection of the hydrant 28. For example, extinguishing water from a hydrant has a pressure of approximately 3 bar. After opening the hydrant 28, the extinguishing water will thus be applied at said pressure at the manifold valve 10 via the second supply line 9. The pressure causes the manifold valve 10 to be switched from the switching position shown in FIG. 4a to the switching position shown in FIG. 4b. In this case, it can be expedient, if necessary, that the pump 26 adjusts the pressure which is generated in the second inflow 9 to the required pressure or pressure range.

However, the pump 26 is particularly important when no hydrant 28 is available but only a body of water, such as a lake 27. In such event, it is often the case that the water surface of the lake is lower-lying than the fire engine 1, and so an actuation of the pump 26 influences the pressure conditions in the second supply line 9 such that the extinguishing water from the lake 27 can reach the conveying pump 5 via the manifold valve 10.

For the pressure control 30 of the manifold valve 10, an elastic element 25, e.g., a spring, can be provided, by means of which the manifold valve 10 is held pre-tensioned in the switching position shown in FIG. 4a. Alternatively or additionally, a magnetic element (not depicted) can also be provided for the pressure control of the manifold valve 10.

The drawing in FIG. 5 shows the display 16, preferably a head-up display, in the helmet 6 of the firefighter. Expediently, the following information can be displayed individually or in any combination via the display 16:
the current filling level 20 of the tank 8 with extinguishing fluid,
the time remaining 21 for releasing extinguishing fluid from the tank 8,
a status indication 22 with regard to the existence of a conveying connection of extinguishing fluid from the stationary extinguishing fluid source 2 to the fire extinguisher device,
a status indication 22 with regard to the non-existence of a conveying connection of extinguishing fluid from the stationary extinguishing fluid source 2 to the fire extinguisher device,
a status indication 23 with regard to the existence and/or non-existence of a radio link and/or
an alarm signal 24 and/or
the switching position of the manifold valve 10.

It must be expressly noted that the inventive concept also includes partial combinations of all of the above features.

### LIST OF REFERENCE SIGNS

1 Fire engine

2 Stationary extinguishing fluid source

3 Hose

4 Extinguisher nozzle

5 Conveying pump

6 Helmet

7 First supply line

8 Tank

9 Second supply line

10 Manifold valve

11 Controller

12 Control line

13 First radio module

14 Second radio module

15 Radio signals

16 Display

17 Display

18 Data interface

18a Plug contact connection

18b Plug contact connection

19 Communication cable

20 Current filling level

21 Time remaining

22 Status indication conveying connection

23 Status indication radio link

24 Alarm signal

25 Elastic element

26 Pump

27 Lake

28 Hydrant

29 Conveying pump control

30 Pressure control

31 Valve

32 Valve

33 Return line

34 Valve

1. Control device for operating a fire extinguisher system,
wherein the fire extinguisher system comprises the following:
at least one hose having an extinguisher nozzle arranged at an end of the hose, by which a pressurized extinguishing fluid is releasable,
a conveying pump for pressurized conveying of the extinguishing fluid in the hose towards the extinguisher nozzle,
a first supply line to the conveying pump from a tank of a fire extinguisher device,
a second supply line to the conveying pump from a stationary extinguishing fluid source,
a controller positioned at a distance from the extinguisher nozzle and functioning as an operations center,
a control line running along the hose the end of the hose with the nozzle, and
a display,
a first radio device connected to the control line proximate the extinguisher nozzle for converting signals from the control line into radio signals and outputting the radio signals,
a second radio device to be carried by the operator of the fire extinguisher system receiving radio signals output by the first radio device, and a display to be carried by the operator of the extinguisher nozzle, on which information based on the transmitted radio signals is displayable.

2. Control device according to claim 1, wherein the display comprises a head-up display.

3. Control device according to claim 1, wherein the information displayed in the display based on the radio signals, is displayable in a further display which is located proximate an operations center.

4. Control device according to claim 1, further comprising a data interface which allows for a parallel data transmission via a communication cable between the control line and the display.

5. Control device according to claim 1, wherein at least one of the following information is displayed in the display:
current filling level of the tank with extinguishing fluid,
time remaining for releasing extinguishing fluid from the tank,
status indication with regard to the existence and/or non-existence of a conveying connection of extinguishing fluid from the stationary extinguishing fluid source to the fire extinguisher device,
status indication with regard to the existence and/or non-existence of a radio link and/or
an alarm signal.

6. Control device according to claim 1, wherein radio signals output by the second radio device are receivable by the first radio device.

7. Control device according to claim 1, wherein a bidirectional voice communication channel is carried out via the control line, the first radio device, and the second radio device.

8. Control device according to claim 1, wherein the extinguisher nozzle is an extinguisher nozzle which is portable by the firefighter or a permanently mounted extinguisher nozzle.

9. Control device according to claim 1, wherein, in the region of the first supply line and second supply line, a pressure-controlled manifold valve is provided upstream of the conveying pump.

10. Control device according to claim 9, wherein the pressure-controlled manifold valve is controlled via pressure applied in the second supply line to the manifold valve.

11. Control device according to claim 9, wherein the pressure applied in the second supply line to the manifold valve is supplied with a pump.

12. Control device according to claim 10, wherein the switching of the manifold valve takes place at a pressure threshold value, and the pressure threshold value is adjustable.

13. Control device according to claim 9, further comprising, in a loaded state of the manifold valve, a flow connection between the tank and pump.

14. Control device according to, claim 9, wherein the manifold valve is spring-loaded and/or magnet-loaded.

15. Control device according to claim 9, wherein a switching position of the manifold valve is displayable on the display.

16. Control device according to claim 9, further comprising a return line from the conveying pump to the tank.

17. Extinguisher nozzle for a fire extinguisher system, for use in a control system for operating a fire extinguisher system according to claim 9,
wherein the first radio device is connected to the control line running along the hose for establishing a data communication connection,
and the first radio device is configured to receive signals via the control line and to output the signals and/or to receive signals originating from a transmitter.

18. Extinguisher nozzle according to claim 17, wherein, for operating the first radio device, the extinguisher nozzle has an electrical energy source, or electrical energy for operating the first radio device is obtained via the control line.
